(19) United States
(12) Patent Application Publication
(10) Pub. No.: US 2016/0105749 A1
(43) Pub. Date: Apr. 14, 2016

(54) SPEAKER WITH EMBEDDED PIEZOELECTRIC TRANSDUCER

(71) Applicant: Knowles Electronics, LLC, Itasca, IL (US)

(72) Inventors: Sarmad Qutub, Des Plaines, IL (US); William Ryan, Villa Park, IL (US)

(21) Appl. No.: 14/878,476

(22) Filed: Oct. 8, 2015

Related U.S. Application Data
(60) Provisional application No. 62/104,189, filed on Jan. 16, 2015.
(60) Provisional application No. 62/062,453, filed on Oct. 10, 2014.

(51) Int. Cl. H04R 17/00; H04R 7/06; H04R 9/06

(52) U.S. Cl. CPC H04R 17/005; H04R 9/06; H04R 7/06; H04R 2499/15; H04R 2307/025; H04R 2307/027

(57) ABSTRACT

In one aspect, a speaker is provided having a coil and a diaphragm assembly coupled to the coil. The diaphragm assembly includes a piezo stiffener plate and a flexible membrane, the piezo stiffener plate including at least one piezo layer and at least one metal layer. The speaker is operable in a human audible frequency operating range and in an ultrasonic frequency operating range. In the ultrasonic frequency operating range, the piezo stiffener plate bends to extend the ultrasonic output beyond the ultrasonic range produced without the use of the piezo stiffener plate. In another aspect, a speaker is provided having a flexible membrane constructed at least partially of a piezo material. The speaker is operable in an ultrasonic frequency operating range wherein the piezo material bends to extend the ultrasonic output beyond the ultrasonic range produced without the use of the piezo material in the membrane.

### CROSS-REFERENCE TO RELATED APPLICATIONS

This patent claims benefit under 35 U.S.C. §119(e) to U.S. Provisional Application No. 62/062,453 entitled “Speaker With Embedded Piezoelectric Transducer” filed Oct. 10, 2014 and U.S. Provisional Application No. 62/104,189 entitled “Speaker With Embedded Piezoelectric Transducer” filed January 16, 2015, the contents of which are incorporated herein by reference in their entireties.

### TECHNICAL FIELD

This application relates to acoustic devices and, more specifically, to transducers deployed in these devices.

### BACKGROUND OF THE INVENTION

Different types of acoustic devices have been used through the years. One type of acoustic device is a speaker or receiver. Generally speaking, a speaker or receiver converts an electrical signal into sound energy. These devices may be used in hearing instruments such as hearing aids or in other electronic devices such as cellular phones and computers.

One type of speaker typically includes a coil, a yoke, an armature (or reed), and magnets. An electrical signal applied to the coil and creates a magnetic field which causes the armature to move. Movement of the armature causes movement of a diaphragm, which creates sound. Together, the magnets, armature, and yoke form a magnetic circuit. The yoke may also serve to hold or support the magnets or other components.

Another type of speaker (dynamic) includes a coil and a diaphragm, which are coupled together. This type of speaker also has fixed magnets. Excitation of the coil creates a magnetic field which, with the presence of the magnets, causes the coil to move. The coil moves the diaphragm and coil in unison (mimicking the action of a moving piston), causing sound to be produced.

Unfortunately, previous approaches have performance limitations. More specifically, previous speakers had difficulty in providing adequate performance in ultrasonic frequency ranges. These problems have limited the usability of speakers and have resulted in some user dissatisfaction.

### BRIEF DESCRIPTION OF THE DRAWINGS

For a more complete understanding of the disclosure, reference should be made to the following detailed description and accompanying drawings wherein:

FIG. 1 comprises a perspective drawing of a speaker according to various embodiments of the present invention;

FIG. 2 comprises a perspective view of the speaker of FIG. 1 with the top plate exploded according to various embodiments of the present invention;

FIG. 3 comprises a perspective, exploded view of the speaker of FIGS. 1-2 according to various embodiments of the present invention;

FIG. 4 comprises an exploded cross section view of the speaker of FIGS. 1-3 according to various embodiments of the present invention;

FIG. 5 comprises a cross section view of the speaker of FIGS. 1-4 according to various embodiments of the present invention;

FIG. 6 comprises a top view of the speaker of FIGS. 1-5 without the cover according to various embodiments of the present invention;

FIG. 7 comprises a top view of the speaker of FIGS. 1-5 with the cover according to various embodiments of the present invention;

FIG. 8 comprises a side cross sectional view of a diaphragm of the speaker of FIGS. 1-7 with the cover according to various embodiments of the present invention;

FIG. 9 comprises a side view of a speaker showing piezoelectric material applied to the case according to various embodiments of the present invention;

FIG. 10 comprises a graph showing operational characteristics of the devices described herein according to various embodiments of the present invention;

FIG. 11 comprises a graph showing operational characteristics of the devices described herein according to various embodiments of the present invention;

FIG. 12A-12E are electrical circuit diagrams showing circuit connections according to various embodiments of the present invention;

FIG. 13 comprises a side cut away view of a stiffening plate according to various embodiments of the present invention;

FIG. 13A comprises a side cut away view of a stiffening plate according to various embodiments of the present invention;

FIG. 14 comprises a diagram of a multi-transducer arrangement according to various embodiments of the present invention;

FIG. 15 comprises a side cut away view of a structure that incorporates piezoelectric material as part of membrane according to various embodiments of the present invention; and

FIG. 16 comprises a view of an example of an overall assembly with the piezoelectric material at different locations in the assembly according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

In the approaches presented herein, piezoelectric materials are used in portions of the speaker to allow operation of the speaker in ultrasonic frequency ranges. In one aspect, the speaker includes a diaphragm assembly with a top plate, and the top plate is constructed at least partially using a piezoelectric structure. The piezoelectric structure, in one aspect, may include a first metal layer, a piezoelectric layer (e.g., a crystalline layer), and a second metal layer. The piezoelectric structure acts as a stiffening plate allowing the response of the speaker to have a wider bandwidth. It also further extends the bandwidth of the speaker to the ultrasonic frequency range when excited with an ultrasonic signal. The piezoelectric layer may be a crystalline structure, lead zirconate titanate (PZT), or barium titanate to mention a few examples. Other examples of materials are possible. In some aspects, the piezoelectric material exhibits motion when an electric field is applied.

In operation, the plate keeps its stiffness (i.e., does not move or bend) until higher (e.g., ultrasonic) frequencies are encountered. Thus, at lower frequencies the diaphragm assembly (plate and membrane) moves up and down in a piston-like action. At higher ultrasonic frequencies, the diaphragm assembly (plate and membrane) may move up and down, and additionally the plate flexes or bends in response to the ultrasonic drive signal.

In some other examples, a piezoelectric structure is disposed on all or portions (e.g., the edge) of the outer casing of the speaker. As mentioned, the piezoelectric structure may include two metal layers and a piezoelectric layer.

The approaches described herein may utilize devices having varying configurations. In one example, the diaphragm assembly has a plate at least partially constructed of a piezoelectric material while the case of the speaker has no piezoelectric edge. In another example, the diaphragm assembly has a plate at least partially constructed of a piezoelectric material while the case of the speaker also has a piezoelectric edge. In still another example, the diaphragm assembly has a plate that is not made of a piezoelectric material while the case of the speaker has a piezoelectric edge.

It will be understood that the approaches described herein operate with audible signals in the approximately 20 Hz-20 kHz range. It will also be understood that the approaches described herein operate with inaudible ultrasonic signals beyond the human audible range of approximately 20 kHz range. Such signals may be any signal that is inaudible to human beings which, while most are above 20 kHz, can be below 20 kHz.

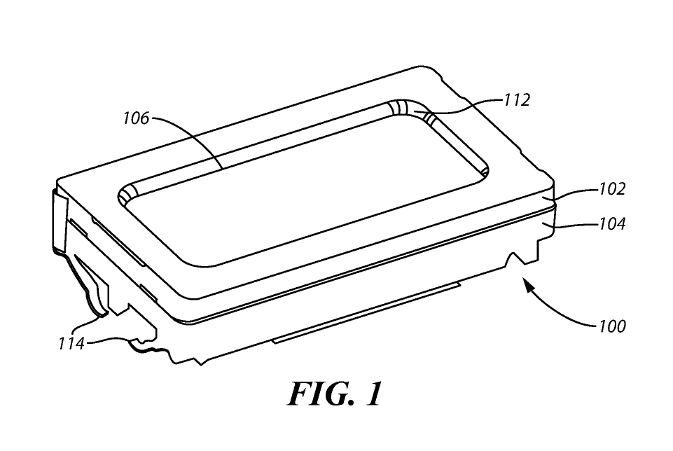

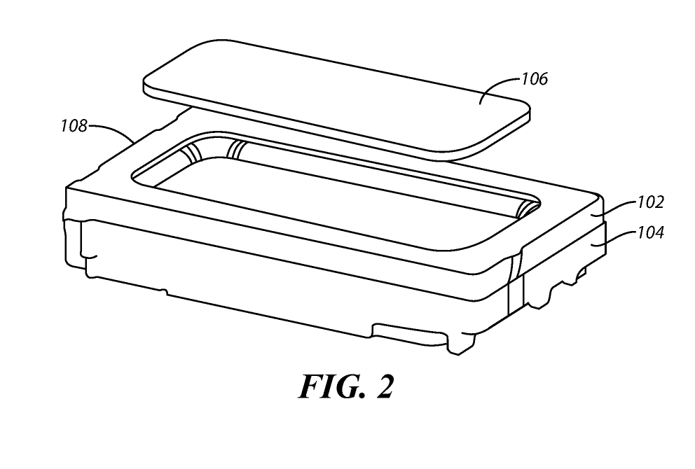

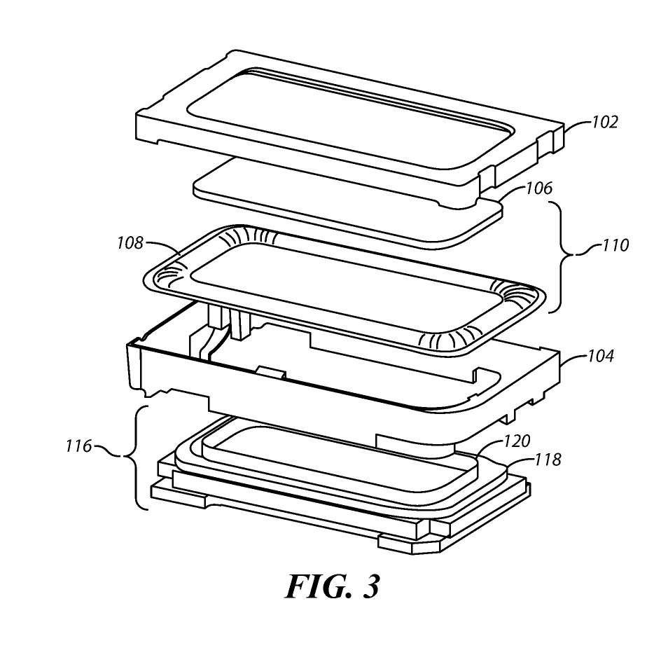

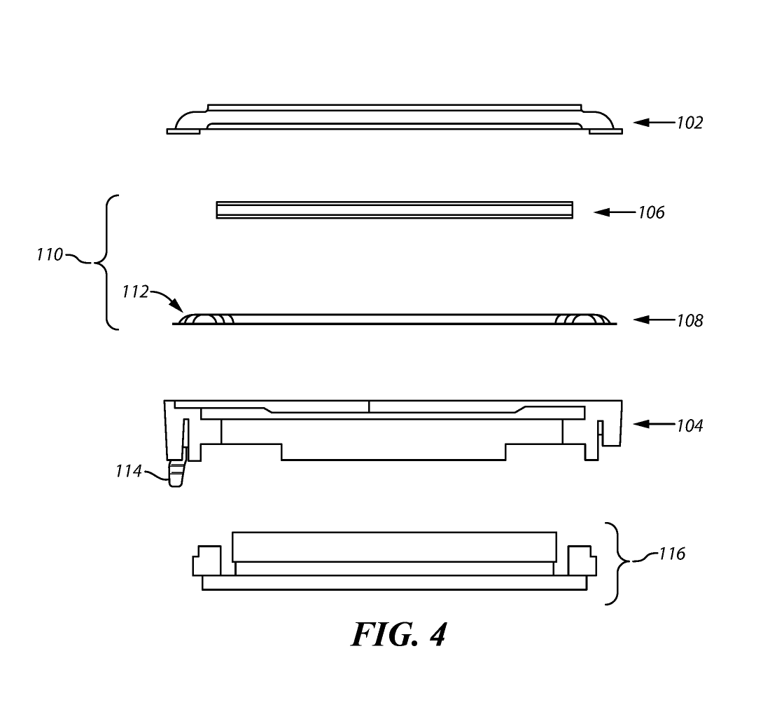

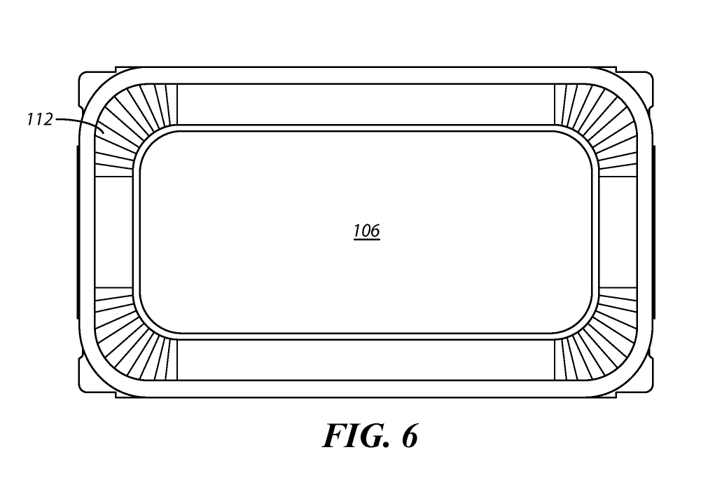

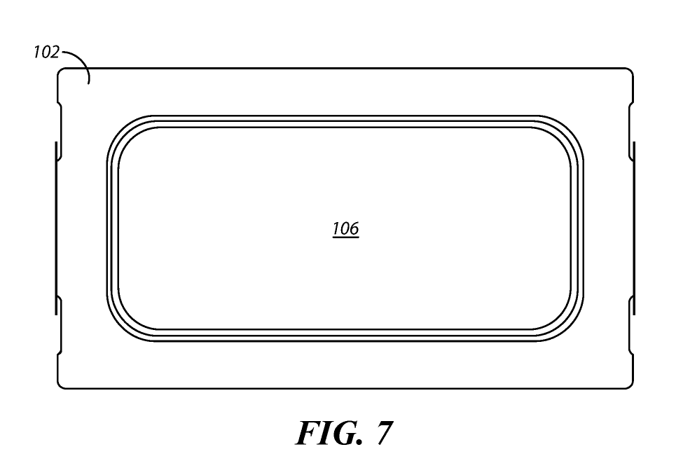

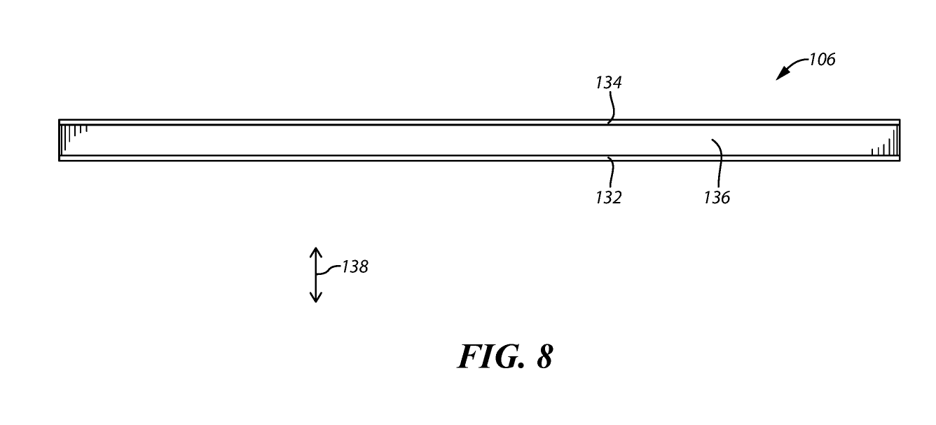

Referring now to FIGS. 1-8, one example of a dynamic speaker 100 is described. The speaker 100 may be disposed in a smart phone, a laptop, a tablet, or an appliance for example. The speaker 100 includes a top speaker casing (or cover) 102, a bottom speaker casing (or basket, or support structure) 104, a diaphragm assembly 110 (including a stiffening plate 106, a membrane 108, and annulus 112), contacts 114, and an acoustic motor 116 (including a coil 118, a center magnet 120, a pot 122). The plate 106, in one example, includes a first metal layer 132, a second metal layer 134, and a piezoelectric layer 136. In another example, the membrane 108 includes a first metal layer, a second metal layer, and a piezoelectric layer.

The top speaker casing or cover 102 attaches to the bottom speaker casing or basket 104. The top speaker casing 102 and the bottom speaker casing 104 may be constructed of any suitable material such as plastic. Together, casings 102 and 104 enclose, hold, and secure the interior elements of the speaker 100.

As mentioned, stiffening plate 106 may be constructed of a first metal layer 132, a second metal layer 134, and a piezoelectric layer 136. In other examples where the top or bottom case 102 or 104 have a piezoelectric edge, the stiffening plate may be constructed with a piezoelectric structure or without a piezoelectric structure.

The membrane 108 may be constructed of any flexible material and is attached to the stiffening plate 106. The annulus 112 is a flexible material in the opening between stiffening plate 106 and the speaker casing 104. The purpose of the annulus 112 is to provide compliance for the movement of the membrane and stiffening plate structure and ensure all motion during transduction is in the vertical axis 138. It will be understood that some speakers may not have membranes and the plate is attached to the edge of the annulus.

The membrane 108 may be constructed of a first metal layer, a second metal layer, and a piezoelectric layer. The metal layer should be adequately thin to allow the annulus 112 to provide compliance to the membrane and stiffening plate.

Electrical contacts 114 provide electrical connections to another device (e.g., an electronic component in a consumer device, or an amplifier to mention two examples). In one aspect, the other device provides an electric signal representative of sound energy.

As mentioned, the acoustic motor 116 includes the coil 118, center magnet 120, and pot 122. Current supplied by the contacts 114 flows through the coil 118. The contacts 114 are also connected in parallel to the piezoelectric structure to create the electric field that produces the ultrasonic output. The coil extends around a periphery of the center magnet 120. The pot 122 creates a path for the static magnetic field. As the current flows, a changing magnetic field is created within the motor and this moves the diaphragm assembly which is rigidly attached to the center plate 106 and coil 118.

The plate 106 includes the first metal layer 132, second metal layer 134, and piezoelectric layer 136. The metal layers 132 and 134 can be constructed of any suitable metal such as copper. The piezoelectric layer 136 exhibits stress when an electric field is applied. The material used to construct the piezoelectric layer 136 may have a crystalline structure, and may be PZT, or barium titanate to mention a few examples. Other examples of materials are possible.

It will be understood that the speaker 100 may be disposed in some other structure such as in a consumer electronic device (e.g., cellular phone, personal computer, laptop computer, or tablet). Features, elements, or components of this other structure together with the speaker may create a front volume and a back volume, in which the diaphragm assembly moves and creates sound. The sound so-created may exit the front volume by a sound tube or channel so that the sound can be presented to a user for listening.

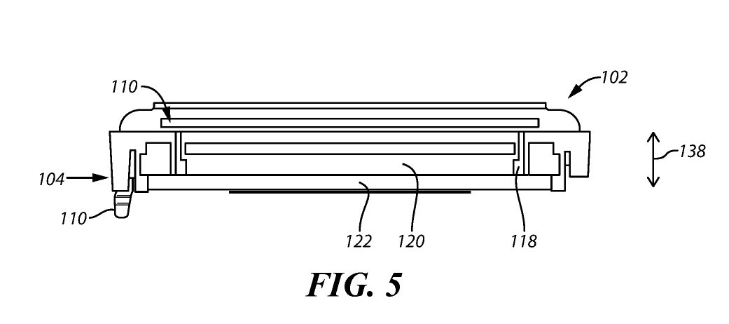

In one example of the operation of the system of FIG. 5, current is applied to the coil 118 via the contacts 114, and this together with the operation of the magnet 120 creates a magnetic field in the motor 116. Responsively, the diaphragm assembly 110 (including the plate 106 and the membrane 108) moves up and down in the direction indicated by the arrow labeled 138. This action creates sound in the front volume that exits the sound tube or some other suitable element.

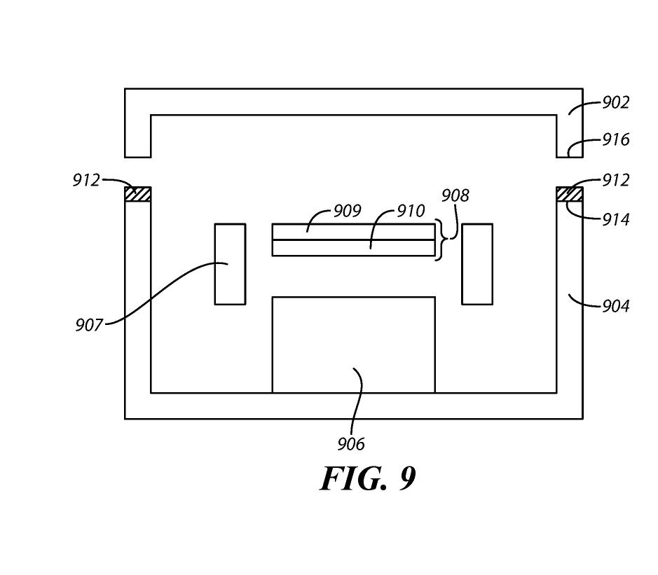

Referring now to FIG. 9, one example of a speaker that includes a piezoelectric structure disposed on the casing of the speaker. As mentioned, the piezoelectric structure may include two metal layers and a piezoelectric layer. In this example, a top casing 902 attaches to a bottom casing 904. A magnet 906, coil 907, a diaphragm assembly 908 (including a plate 909 and membrane 910) are disposed within the casings 902 and 904. A piezoelectric layer 912 is disposed on an edge (or lip) 914 of the bottom casing 904. Alternatively, the piezoelectric layer 912 may be disposed on an edge 916 of the top casing 902, or on both the top and bottom casing. In this example, the plate 909 may or may not be constructed using a piezoelectric material. These elements have been described above with respect to FIGS. 1-8 and will not be described again here.

In one example, the plate 909 has a piezoelectric structure. In other examples, the plate 909 does not have a piezoelectric structure. In other aspects, the piezoelectric material provides operation of the speaker in the ultrasonic frequency range.

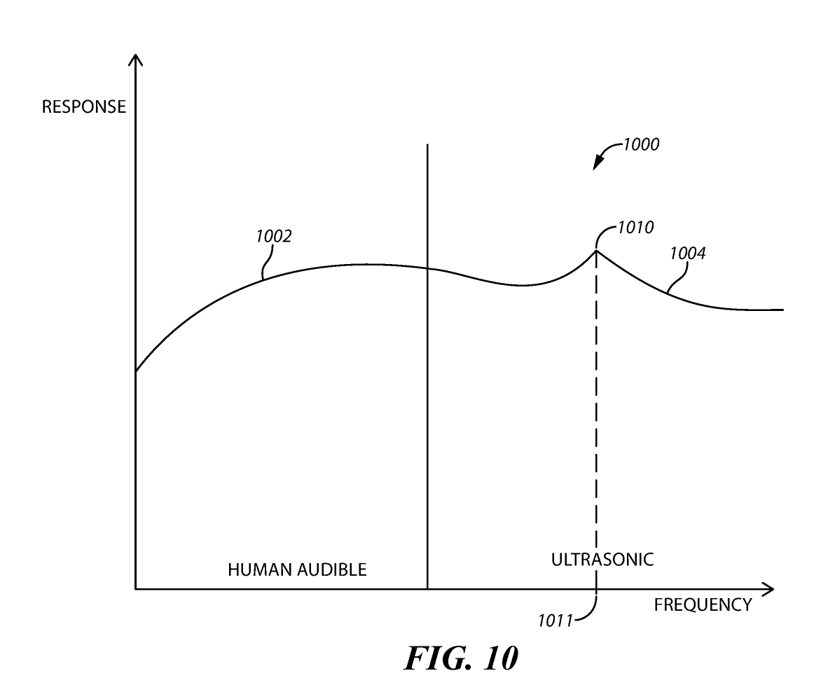

Referring now to FIG. 10, one example of the response characteristics of the devices provided herein are described. A curve 1000 shows the response characteristics of a device with a plate that is constructed of piezoelectric materials. In this example, the edge portions of the casings are not covered with piezoelectric materials

A first portion 1002 of the curve 1000 shows the responses at lower audible frequencies. In this portion of the operating range, the plate may keep its stiffness (i.e., the plate does not bend or warp). During this range the diaphragm assembly is primarily moving up and down like a piston.

As the frequency of operation increases (i.e., higher frequency signals are received), the plate begins to bend. The second portion 1004 of the curve 1000 shows this area of operation. During operations in the ultrasonic frequency range, the diaphragm assembly may be also moving up and down like a piston even as the plate bends. It will be appreciated that the bending of the plate caused by application of an electric field (allowed by the piezoelectric configuration) increases ultrasonic output.

It will be understood that a user can tune or adjust the resonance for a peak at a frequency in the ultrasonic band. That is, characteristics of the plate can be selected so that a certain peak response 1010 at a resonant frequency 1011 is reached. This can be adjusted by the user, for example, by selecting appropriate composition, crystal cut, and dimensions of the piezoelectric plate.

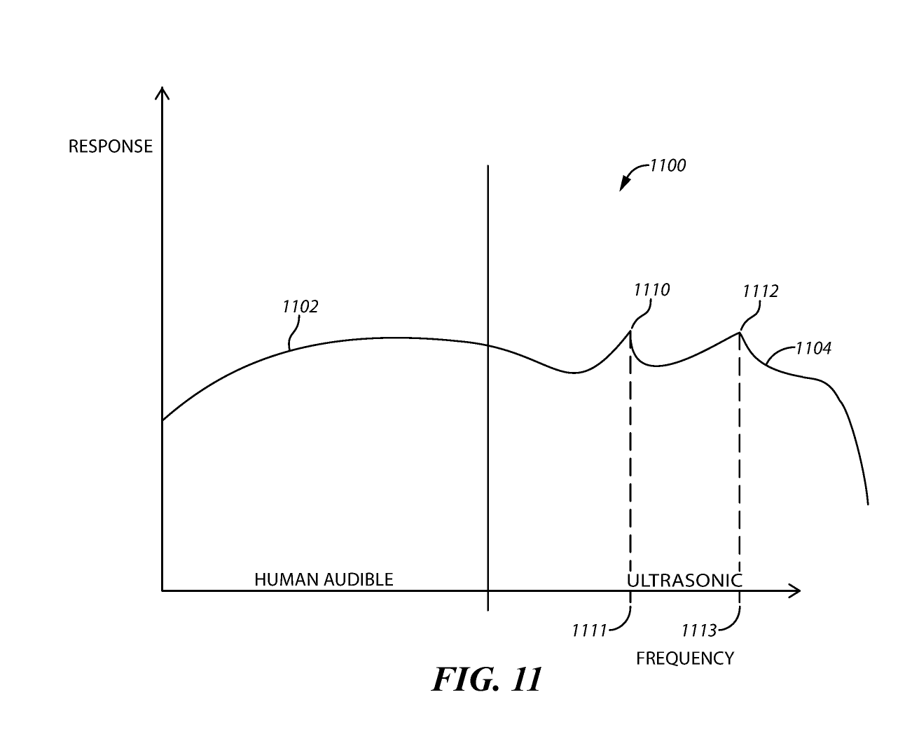

Referring now to FIG. 11, one example of the response characteristics are described with piezoelectric plate and a piezoelectric edge on the casing. A curve 1100 shows the response characteristics of a device with a plate that is constructed of piezoelectric materials and also with casings that have edge portions utilizing piezoelectric structures.

A first portion 1102 of the curve 1100 shows the responses at lower audible frequencies. In this portion of the operating range, the plate may keep its stiffness (i.e., the plate does not bend or warp). During this range the diaphragm assembly is primarily moving up and down like a piston.

As the frequency of operation increases (i.e., higher frequency signals are received), the plate begins to bend. The second portion 1104 of the curve 1100 shows this area of operation. During this range the diaphragm assembly may be also moving up and down like a piston even as the plate bends. It will be appreciated that the bending of the plate caused by application of an electric field (allowed by the piezoelectric configuration) increases ultrasonic output.

It will be understood that a user can tune the resonance for a peak at a frequency in the ultrasonic band for the plate. That is, the piezoelectric material of the plate can be selected so that a certain peak resonant response 1110 at a first resonant frequency 1111 is reached. This can be adjusted by the user, for example, by selecting appropriate composition, crystal cut, and dimensions of the piezoelectric plate.

It will be further understood that a user can tune the resonance for a peak at a frequency in the ultrasonic band for the edge portions. That is, the piezoelectric material of the plate can be selected so that a certain peak response 1112 at a second resonant frequency 1113 is reached. This can be adjusted by the user, for example, by selecting appropriate composition, crystal cut, and dimensions of the piezoelectric plate.

Additionally, although shown here as having two peak responses 1110 and 1112 of different frequencies, the same frequency can be selected for the plate and the edge portions. In this situation, the two resonant responses will add together creating a greater response than would occur if different resonant frequencies were used.

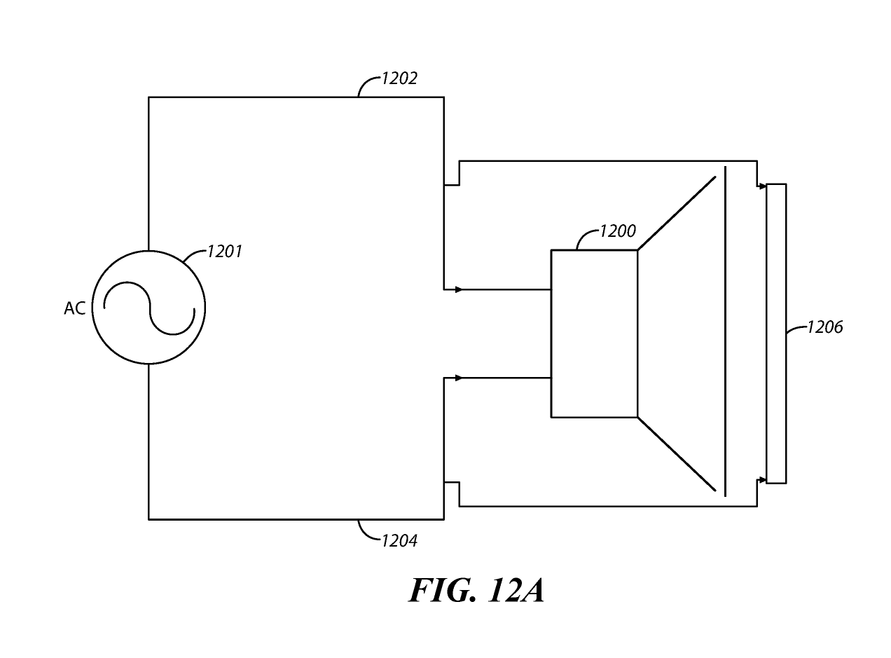

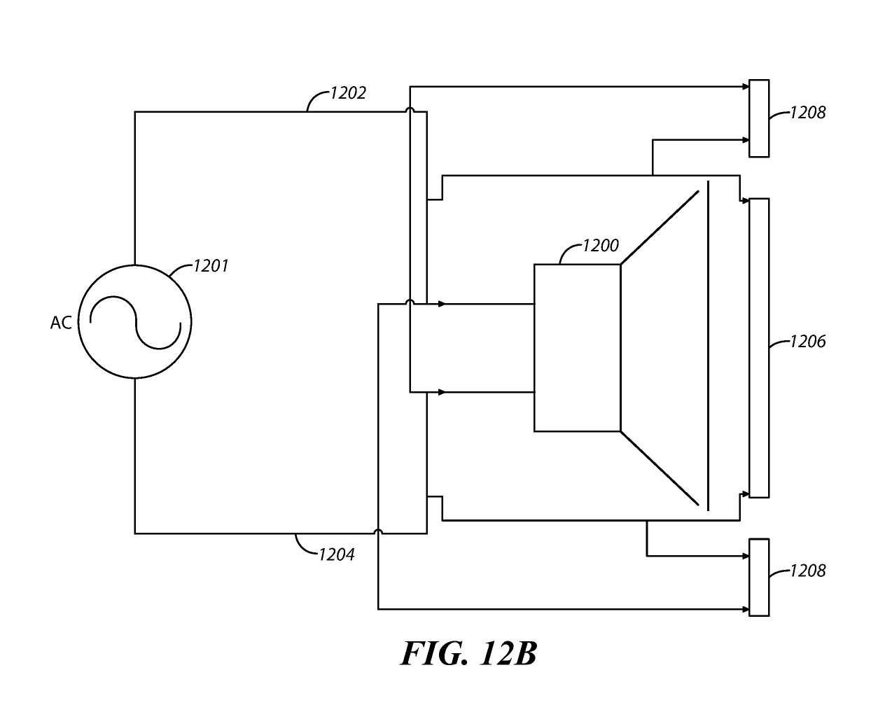

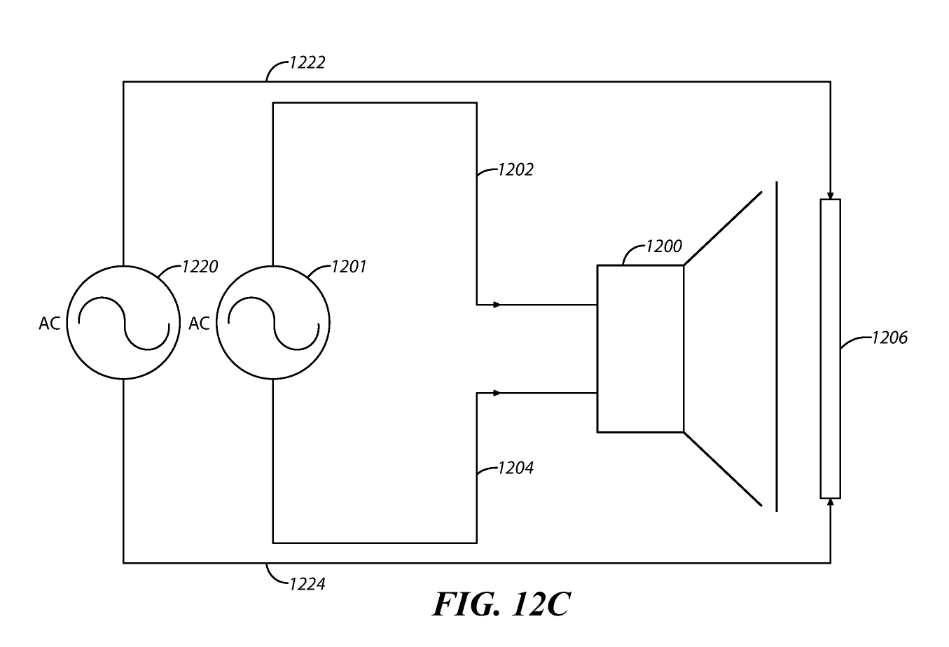

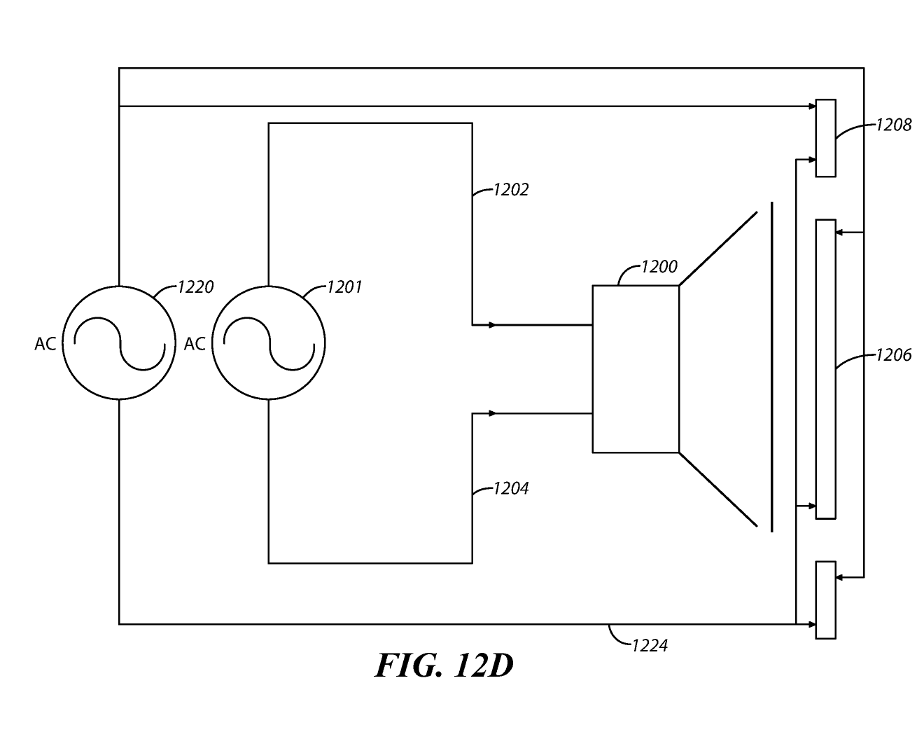

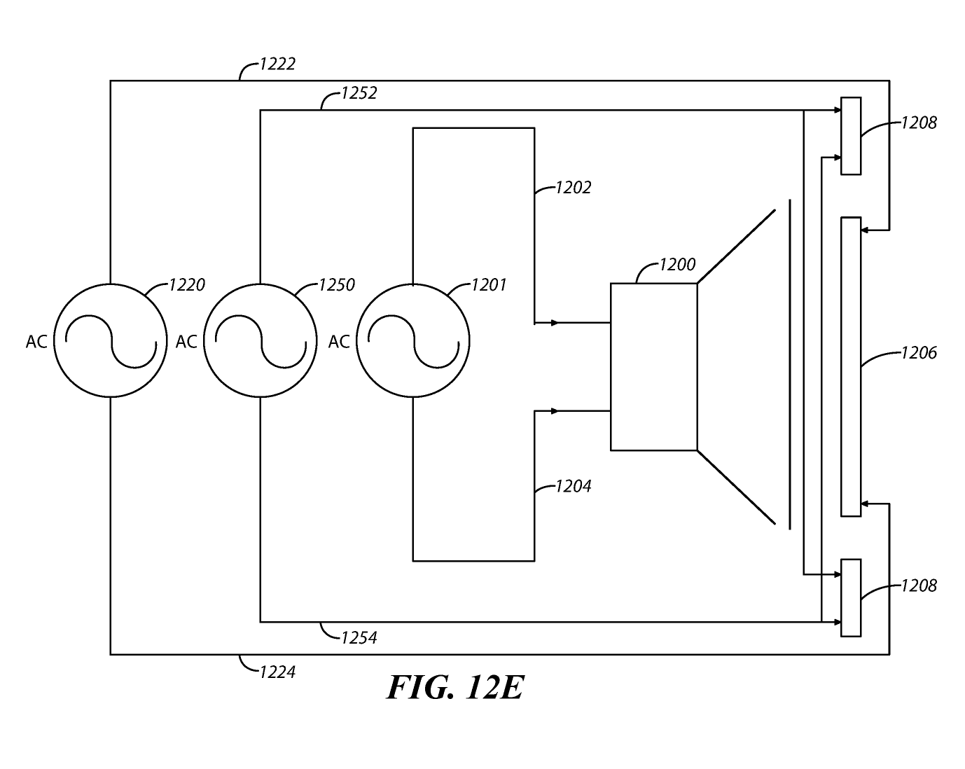

Referring now to FIG. 12A-12E, various examples of the electrical connections to a speaker 1200 are described. In the examples of FIG. 12A and 12B, contacts 1202 and 1204 are also connected in parallel to the piezoelectric structure from each side of an alternating current source 1201 to create the electric field that produces the ultrasonic output. In FIG. 12A, the contacts 1202 and 1204 are coupled to a plate 1206 having a piezoelectric structure. In FIG. 12B, the contacts 1202 and 1204 are coupled to a plate 1206 having a piezoelectric structure, and to a piezoelectric structure 1208 disposed on the edge portion of the case of the speaker 1200. Although not shown, this same electrical configuration can be used when only a piezoelectric structure 1208 is used.

In the examples of FIG. 12C and 12D, a second alternating current source 1220 is used. Contacts 1202 and 1204 (of first alternating current source 1201) are connected to the speaker 1200 and contacts 1222 and 1224 (of the second alternating current source 1220) are connected to the piezoelectric structure from each side of the alternating current source 1220 to create the electric field that produces the ultrasonic output. More specifically, the contacts 1222 and 1224 are coupled to a plate 1206 having a piezoelectric structure.

In FIG. 12D, the contacts 1222 and 1224 are coupled to the plate 1206 having a piezoelectric structure, and additionally to a piezoelectric structure 1208 disposed on the edge portion of the case of the speaker 1200.

In the example of FIG. 12E, a third alternating current source 1250 is used. Contacts 1202 and 1204 are connected to the speaker 1200. Contacts 1222 and 1224 of the second alternating current source 1220 are connected to the plate 1206 having a piezoelectric structure. Contacts 1252 and 1254 are connected to a piezoelectric structure 1208 disposed on the edge portion of the case of the speaker 1200.

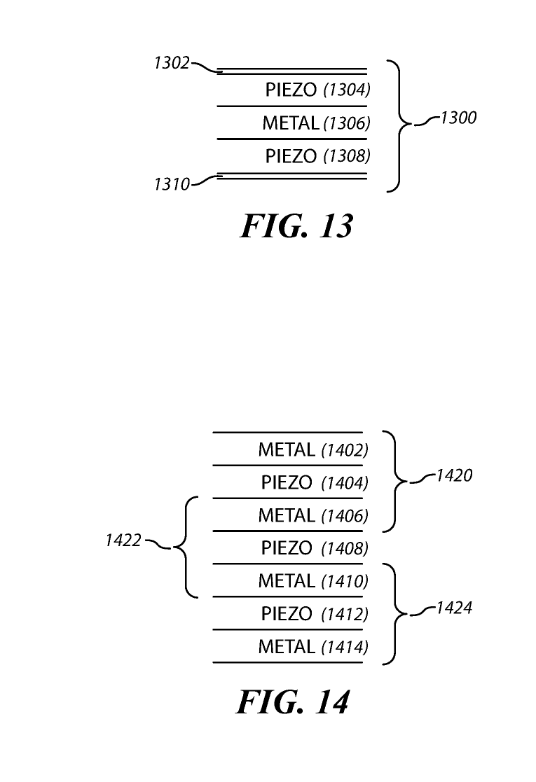

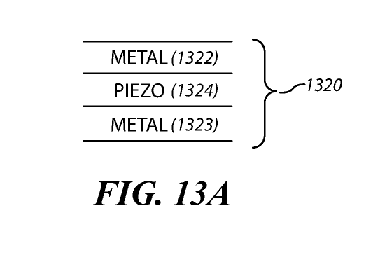

Referring now to FIG. 13, an example of a layered stiffening plate (or piezoelectric structure) 1300 is described. The layered stiffening plate 1300 includes a first metal layer 1302, a first piezoelectric layer 1304, a core metal layer 1306, a second piezoelectric layer 1308, and a second metal layer 1310. The first metal layer 1302 and the second metal layer 1310 provide electrical contacts for the plate so that the plate can be driven by an electrical signal. The core metal layer 1306 provides for stiffening of the structure 1300. The piezoelectric layers 1304 and 1308 provide the advantages as described elsewhere herein and can be constructed of the same materials. Metal layer 1306 can also provide an electrical contact used to apply an electric field across piezoelectric layers 1304 or 1308 with metal layers 1302 and 1310 respectively. This results in a structure wherein the two piezoelectric layers 1304 and 1308 function independently in the transmission of the ultrasonic signal.

Referring now to FIG. 13A, an example of a single layered stiffening plate (or piezoelectric structure) 1320 is described. The layered stiffening plate 1320 includes a first metal layer 1322, a piezoelectric layer 1324, and a second metal layer 1323. The first metal layer 1322 and the second metal layer 1323 provide electrical contacts for the plate so that the plate can be driven by an electrical signal and provides for stiffening of the structure 1320. The piezoelectric layer 1324 provides the advantages as described elsewhere herein and can be constructed of the same materials.

Referring now to FIG. 14, one example of a multi-transducer arrangement 1400 is described. The arrangement 1400 includes a first metal layer 1402, a first piezoelectric layer 1404, a second metal layer 1406, a second piezoelectric layer 1408, a third metal layer 1410, a third piezoelectric layer 1412, and a fourth metal layer 1414.

With this arrangement, multiple transducers that share layers are provided. A first transducer 1420 includes the first metal layer 1402, the first piezoelectric layer 1404, and the second metal layer 1406. A second transducer 1422 includes the second metal layer 1406, the second piezoelectric layer 1408, and the third metal layer 1410. A third transducer 1424 includes the third metal layer 1410, the third piezoelectric layer 1412, and the fourth metal layer 1414.

The structure of these layered piezoelectric transducers allows them to be driven independently, yielding greater output at ultrasonic frequencies.

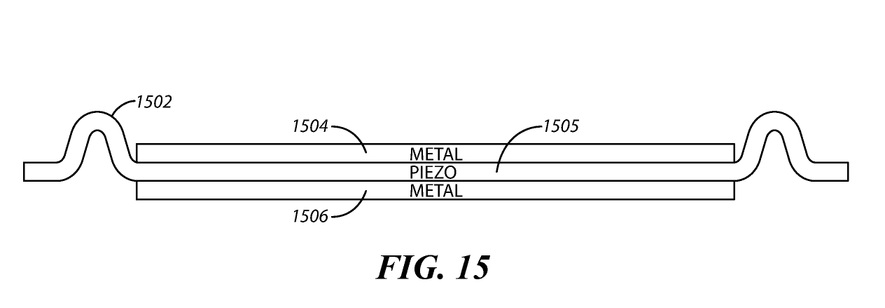

Referring now to FIG. 15, one example of a diaphragm that incorporates piezoelectric material as part of a membrane is described. The membrane 1502 may be formed of piezoelectric material at least in a central portion 1505 of the membrane 1502. A first metal layer 1504 is disposed on a first side of the membrane 1502 and a second metal layer 1506 is disposed on a second side of the membrane 1502. In some instances the metal layers 1504 and 1506 are extended beyond the central portion of the membrane 1505 to also cover the full membrane 1502.

This particular diaphragm is advantageous because it minimizes the addition of components to integrate the piezo structure, resulting in lower mass for better higher output at audio frequencies and lower overall cost of the component.

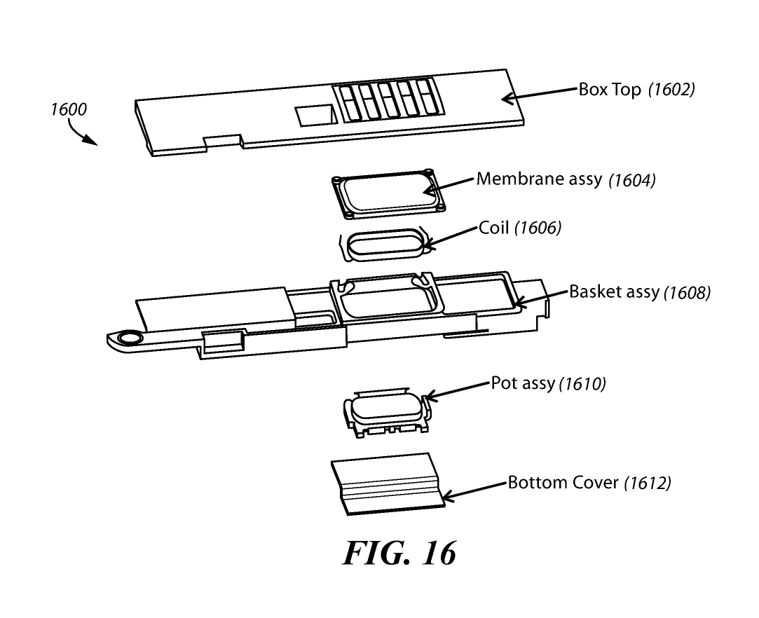

Referring now to FIG. 16, examples of overall assemblies with the piezoelectric material at different locations in a speaker assembly is described. A speaker assembly 1600 includes a top 1602, a membrane or diaphragm assembly 1604, a coil 1606, a basket assembly 1608, a pot assembly 1610, and a bottom cover 1612. The functions of the membrane or diaphragm assembly 1604, coil 1606, and pot assembly 1610 have been described above and will not be described here again. The membrane or diaphragm assembly 1604, coil 1606, and pot assembly 1610 are configured to fit into the basket assembly 1608, which itself may be disposed in another device. The top 1602 and bottom cover 1612 cover the internal components.

As described above, a plate within the diaphragm assembly 1604 may be constructed of piezoelectric material. In some examples, however, the plate does not include a piezoelectric structure. Piezoelectric material may be disposed (e.g., in the shape of strips) at other locations of the assembly 1600 (e.g. the box top 1602 or basket assembly 1608). The position of the piezoelectric material located throughout the assembly 1610 or 1608 is selected so as to offer flexibility in the application's industrial design and optimize audio and ultrasonic performance. Consequently, the piezoelectric material at the locations exterior to the diaphragm assembly 1604 provides operation of the assembly or module 1600 in the ultrasonic frequency range.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A speaker, the speaker comprising:
a housing forming a cavity;
a coil disposed in the cavity;
a diaphragm assembly coupled to the coil and disposed in the cavity, the diaphragm assembly comprising a piezo stiffener plate and a flexible membrane, the piezo stiffener plate including at least one piezo layer and at least one metal layer;
such that an electrical signal excites the coil to produce an electrical current, the electric current moving the coil, the movement of the coil responsively moving the diaphragm assembly to produce sound energy;
such that the speaker operates in a human audible frequency operating range and an ultrasonic frequency operating range;
wherein in the ultrasonic frequency operating range the piezo stiffener plate bends to extend the ultrasonic output of the speaker beyond the ultrasonic frequency operating range produced without use of the piezo stiffener plate.

2. The speaker of claim 1, wherein the housing includes an upper housing portion and a lower housing portion forming the cavity therebetween; and
a piezo electric layer disposed on at least one of a first lip of the upper housing portion and a second lip on the lower housing portion.

3. The speaker of claim 1, wherein the coil and the plate are driven by a single alternating current source.

4. The speaker of claim 1, wherein the coil and the plate are driven by different alternating current sources.

5. The speaker of claim 1, wherein the speaker is disposed in a smart phone, a laptop computer, a tablet, or an appliance.

6. A speaker, the speaker comprising:
a housing forming a cavity;
a coil disposed in the cavity;
a flexible membrane coupled to the coil and disposed in the cavity, the flexible membrane being constructed at least partially of a piezo material;
such that an electrical signal excites the coil to produce an electrical current, the electric current moving the coil, the movement of the coil responsively moving the membrane to produce sound energy;
such that the speaker operates in a human audible frequency operating range and an ultrasonic frequency operating range;
wherein in the ultrasonic frequency operating range the piezo material bends to extend the ultrasonic output beyond the ultrasonic frequency operating range produced without use of the piezo material in the membrane.

7. The speaker of claim 6, wherein the housing includes an upper housing portion and a lower housing portion forming the cavity therebetween; and
a piezo electric layer disposed on at least one of a first lip of the upper housing portion and a second lip on the lower housing portion.

8. The speaker of claim 6, wherein the coil and the piezo material are driven by a single alternating current source.

9. The speaker of claim 6, wherein the coil and the piezo material are driven by different alternating current sources.

10. The speaker of claim 6, wherein the speaker is disposed in a smart phone, a laptop computer, a tablet, or an appliance.

11. The speaker of claim 6, wherein the membrane includes at least one layer of piezo material and at least one metal layer.

12. The speaker of claim 11, wherein the membrane includes two metal layers disposed on opposite sides of the piezo material.

13. A speaker, the speaker comprising:
an upper housing and a lower housing, the upper housing coupled to the lower housing and forming a cavity therebetween;
a coil disposed in the cavity;
a flexible membrane coupled to the coil and disposed in the cavity;
such that an electrical signal excites the coil to produce an electrical current, the electric current moving the coil, the movement of the coil responsively moving the membrane to produce sound energy;
a piezo electric layer disposed on at least one of a first lip of the upper housing and a second lip on the lower housing;
such that the speaker operates in a human audible frequency operating range and an ultrasonic frequency operating range;
wherein in the ultrasonic frequency operating range the piezo material bends to extend the ultrasonic output beyond the ultrasonic frequency operating range produced without use of the piezo material on the housing.

14. The speaker of claim 13, wherein the coil and the piezo electric layer are driven by a single alternating current source.

15. The speaker of claim 13, wherein the coil and the piezo electric layer are driven by different alternating current sources.

16. The speaker of claim 13, wherein the speaker is disposed in a smart phone, a laptop computer, a tablet, or an appliance.

17. A method of operating a speaker, the method comprising:
moving a diaphragm to produce sound in a human audible frequency operating range;
moving the diaphragm to produce sound in an ultrasonic frequency operating range;
bending a piezo material to extend the ultrasonic range of the diaphragm.

18. The method of claim 17, wherein moving the diaphragm to produce sound in the human audible frequency operating range and moving the diaphragm to produce sound in the ultrasonic frequency range includes moving a piezo stiffener plate and a flexible membrane of the diaphragm.

19. The method of claim 17, wherein bending the piezo material includes bending piezo material disposed on a housing supporting the diaphragm.

20. The method of claim 17, wherein moving the diaphragm to produce sound in the human audible frequency operating range does not include bending the piezo material.

21. The method of claim 17, wherein bending the piezo material includes bending a plurality of layers of piezo material.

22. The method of claim 17, wherein moving the diaphragm to produce sound in the ultrasonic frequency operating range includes moving the diaphragm in a housing and bending the piezo material to extend the ultrasonic range of the diaphragm includes bending the piezo material in the housing.
